(19) United States
(12) Patent Application Publication
(10) Pub. No.: US 2018/0158242 A1
(43) Pub. Date: Jun. 7, 2018

(54) INFORMATION PROCESSING METHOD AND PROGRAM FOR EXECUTING THE INFORMATION PROCESSING METHOD ON COMPUTER

(71) Applicant: COLOPL, INC., Tokyo (JP)

(72) Inventor: Kenta Sugawara, Tokyo (JP)

(21) Appl. No.: 15/829,836

(22) Filed: Dec. 1, 2017

(30) Foreign Application Priority Data
Dec. 1, 2016 (JP) 2016-234015

(51) Int. Cl. G06T 19/00; G06F 3/01

(52) U.S. Cl. CPC G06T 19/003; G06F 3/013; H04N 13/044; G06F 3/012

(57) ABSTRACT

A method includes receiving a signal requesting content, wherein the content defines a virtual space displayable on a head mounted display (HMD). The method further includes determining sub-content to be displayed in the virtual space. The method further includes determining a display condition, wherein the display condition defines a timing for displaying the sub-content in the virtual space. The method further includes instructing a user terminal including the HMD to display the content and the sub-content based on the determined display condition.

### RELATED APPLICATIONS

The present application claims priority to Japanese Patent Application No. 2016-234015, filed Dec. 1, 2016, the disclosure of which is hereby incorporated by reference herein in its entirety.

### TECHNICAL FIELD

This disclosure relates to an information processing method and a system for executing the information processing method.

### BACKGROUND

In Patent Document 1, there is described a technology of displaying an advertisement in a virtual space generated by a related-art game console, for example, PlayStation®. In Patent Document 1, action histories of a large number of users in a virtual space are collected, a land price of each location in the virtual space is set based on the collected action histories of the large number of users, and an advertisement rate of a predetermined location is determined based on a land price of the predetermined location.

In Patent Document 2, an action state of a user is analyzed by detecting, for example, a line of sight of the user, priorities for a plurality of display items are set depending on the action state of the user, and display of the plurality of display items is controlled depending on the priorities set for the plurality of display items. In Patent Document 2, a visibility of a display item having a low priority is decreased by increasing transparency of the display item.

### PATENT DOCUMENTS

[Patent Document 1] JP 2003-248844 A

[Patent Document 2] JP 2014-071811 A

### SUMMARY

At least one embodiment of this disclosure helps to provide an information processing method capable of increasing an advertisement effect in virtual experience content and a system for implementing the information processing method.

According to at least one embodiment of this disclosure, an information processing method is executed by a processor in a virtual experience content distribution system. The virtual experience content distribution system includes a user terminal and a server. The user terminal including a head-mounted device, which is mountable on a head of a user, and is configured to display a visual-field image of virtual experience content. The information processing method includes receiving a virtual experience content request for requesting the virtual experience content from the user terminal. The method further includes determining sub-content to be displayed in the virtual experience content. The method further includes determining a sub-content display condition that defines a timing to display the sub-content. The method further includes transmitting data on the virtual experience content, data on the sub-content, and the sub-content display condition to the user terminal.

### BRIEF DESCRIPTION OF THE DRAWINGS

FIG. 1 A schematic diagram of a virtual experience content distribution system in at least one embodiment of this disclosure.

FIG. 2 A schematic diagram of a user terminal in at least one embodiment of this disclosure.

FIG. 3 A diagram of a head of a user wearing an HMD in at least one embodiment of this disclosure.

FIG. 4 A diagram of a hardware configuration of a control device in at least one embodiment of this disclosure.

FIG. 5 A flowchart of processing for displaying a visual-field image on the HMD in at least one embodiment of this disclosure.

FIG. 6 An xyz spatial diagram of a virtual space in at least one embodiment of this disclosure.

FIG. 7A A yx plane diagram of the virtual space in at least one embodiment of this disclosure.

FIG. 7B A zx plane diagram of the virtual space in at least one embodiment of this disclosure.

FIG. 8 A diagram of the visual-field image displayed on the HMD in at least one embodiment of this disclosure.

FIG. 9 A diagram of a hardware configuration of a server in at least one embodiment of this disclosure.

FIG. 10 A sequence diagram of an operation of the virtual experience content distribution system in at least one embodiment of this disclosure.

FIG. 11A A diagram of an advertisement interest level table for showing an interest level of each user in each advertisement content in at least one embodiment of this disclosure.

FIG. 11B A diagram of an advertisement attribute table for including an attribute of each advertisement in at least one embodiment of this disclosure.

FIG. 12 A diagram of an advertisement content object arranged in the virtual space in at least one embodiment of this disclosure.

FIG. 13 A diagram of a relative positional relationship between a visual axis of a virtual camera and an advertisement content display region in at least one embodiment of this disclosure.

FIG. 14A A table of first line-of-sight information data representing a relationship between an elapsed time and an angle in at least one embodiment of this disclosure.

FIG. 14B A graph of the relationship between the elapsed time and the angle in at least one embodiment of this disclosure.

FIG. 15A A table of second line-of-sight information data representing a relationship between the elapsed time and the distance in at least one embodiment of this disclosure.

FIG. 15B A graph of the relationship between the elapsed time and the distance in at least one embodiment of this disclosure.

FIG. 16 A flowchart of an advertisement content display condition that uses the angle in at least one embodiment of this disclosure.

FIG. 17 A graph of a relationship between the angle and the elapsed time for the advertisement content display condition in at least one embodiment of this disclosure.

### DETAILED DESCRIPTION

Embodiments of this disclosure are described below with reference to the drawings. Once a component is described in this description of the embodiments, a description on a component having the same reference number as that of the already described component is omitted for the sake of brevity.

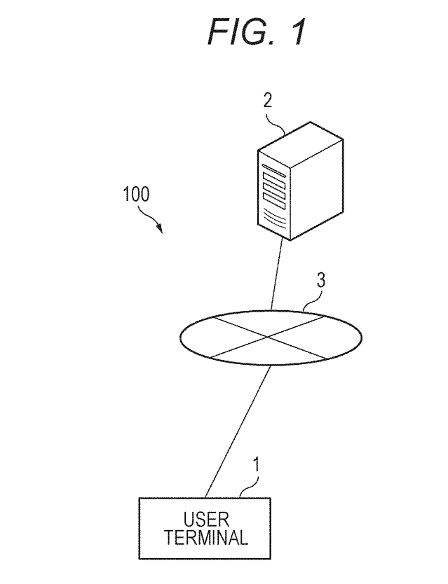

With reference to FIG. 1, a description is given of a schematic configuration of a virtual experience content distribution system in at least one embodiment. FIG. 1 is a schematic diagram of a virtual experience content distribution system 100 (hereinafter referred to simply as “distribution system 100”). In FIG. 1, the distribution system 100 includes a user terminal 1 operated by a user U and a server 2 configured to distribute virtual experience content. The user terminal 1 is connected to the server 2 through a communication network 3, for example, the Internet, so as to enable communication between the user terminal 1 and the server 2. The virtual experience content is, for example, video content for providing the user U with a virtual experience, and may be provided as a virtual space including a plurality of objects or a virtual space including a 360 degree image, for example, an omnidirectional image. A virtual camera is arranged at the center position of the virtual space including a 360 degree image, and a 360 degree image is displayed on the surface of the virtual space. In at least one embodiment, the “image” refers to either a still image or a moving image (video) formed of a plurality of frame images. In at least one embodiment, a virtual space includes a virtual reality (VR) space, an augmented reality (AR) space, and a mixed reality (MR) space.

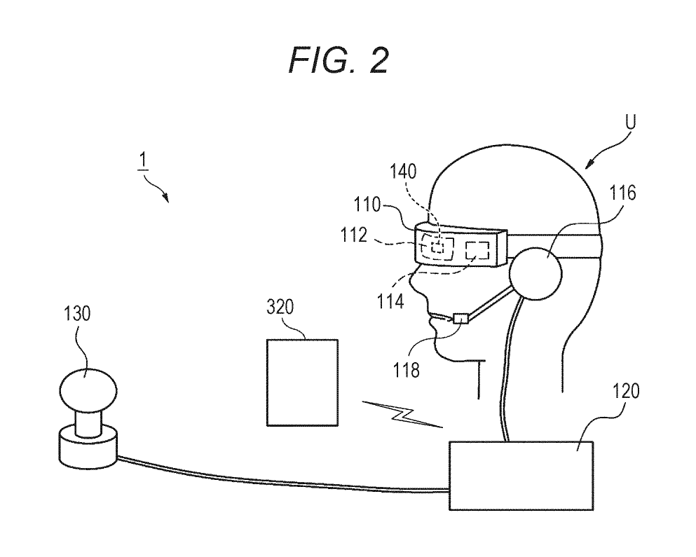

With reference to FIG. 2, a description is given of a configuration of the user terminal 1. FIG. 2 is a schematic diagram of the user terminal 1. In FIG. 2, the user terminal 1 includes a head-mounted device (HMD) 110 worn on a head of the user U, headphones 116, a microphone 118, a position sensor 130, an external controller 320, and a control device 120.

The HMD 110 includes a display unit 112, an HMD sensor 114, and an eye gaze sensor 140. The display unit 112 includes a non-transmissive display device configured to completely cover a field of view (visual field) of the user U wearing the HMD 110. With this, the user U can see only a visual-field image displayed on the display unit 112, and hence the user U can be immersed in a virtual space. The display unit 112 may include a left-eye display unit configured to provide an image to a left eye of the user U, and a right-eye display unit configured to provide an image to a right eye of the user U. The HMD 110 may include a transmissive display device. In this case, the transmissive display device may be configured to temporarily function as a non-transmissive display device through adjustment of a transmittance.

The HMD sensor 114 is mounted near the display unit 112 of the HMD 110. The HMD sensor 114 includes at least one of a geomagnetic sensor, an acceleration sensor, or an inclination sensor (for example, an angular velocity sensor or a gyro sensor), and can detect various motions of the HMD 110 worn on the head of the user U.

The eye gaze sensor 140 has an eye tracking function of detecting a line-of-sight direction of the user U. For example, the eye gaze sensor 140 may include a right-eye gaze sensor and a left-eye gaze sensor. The right-eye gaze sensor may detect reflective light reflected from the right eye (cornea or iris) of the user U by irradiating the right eye with, for example, infrared light, to thereby acquire information relating to a rotational angle of a right eyeball. Meanwhile, the left-eye gaze sensor may detect reflective light reflected from the left eye (cornea or iris) of the user U by irradiating the left eye with, for example, infrared light, to thereby acquire information relating to a rotational angle of a left eyeball.

The headphones 116 are worn on right and left ears of the user U. The headphones 116 are configured to receive sound data (electrical signal) from the control device 120 to output sounds based on the received sound data. The microphone 118 is configured to collect sounds uttered by the user U, and to generate sound data (electric signal) based on the collected sounds. The microphone 118 is also configured to transmit the sound data to the control device 120.

The position sensor 130 includes, for example, a position tracking camera, and is configured to detect the positions of the HMD 110 and the external controller 320. The position sensor 130 is connected to the control device 120 so as to enable communication to/from the control device 120 in a wireless or wired manner. The position sensor 130 is configured to detect information relating to positions, inclinations, or light emitting intensities of a plurality of detection points (not shown) provided in the HMD 110. The position sensor 130 is configured to detect information relating to positions, inclinations, and/or light emitting intensities of a plurality of detection points (not shown) provided in the external controller 320. The detection points are, for example, light emitting portions configured to emit infrared light or visible light. The position sensor 130 may include an infrared sensor or a plurality of optical cameras.

The external controller 320 is used to control, for example, the motion of a finger object to be displayed in the virtual space. The external controller 320 may include a right-hand external controller to be used by being held by a right hand of the user U, and a left-hand external controller to be used by being held by a left hand of the user U.

The control device 120 is capable of acquiring information on the position of the HMD 110 based on the information acquired from the position sensor 130, and accurately associating the position of the virtual camera in the virtual space with the position of the user U wearing the HMD 110 in the real space based on the acquired information on the position of the HMD 110. The control device 120 is capable of acquiring information on the position of the external controller 320 based on the information acquired from the position sensor 130, and accurately associating the position of the finger object to be displayed in the virtual space with a relative positional relationship between the external controller 320 and the HMD 110 in the real space based on the acquired information on the position of the external controller 320.

The control device 120 is capable of identifying the line of sight of the right eye and the line of sight of the left eye of the user U based on the information transmitted from the eye gaze sensor 140, to thereby identify a point of gaze being an intersection between the line of sight of the right eye and the line of sight of the left eye. The control device 120 is capable of identifying a line-of-sight direction of the user U based on the identified point of gaze. The line-of-sight direction of the user U is a line-of-sight direction of both eyes of the user U, and matches a direction of a straight line passing through the point of gaze and a midpoint of a line segment connecting between the right eye and the left eye of the user U.

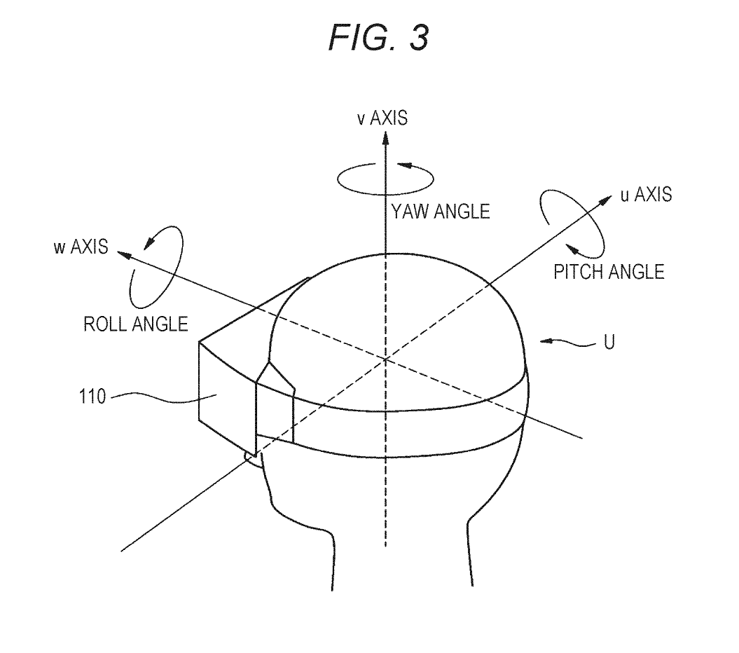

With reference to FIG. 3, a method of acquiring information relating to a position and an inclination of the HMD 110 is described. FIG. 3 is a diagram of the head of the user U wearing the HMD 110. The information relating to the position and the inclination of the HMD 110, which move in association with the motion of the head of the user U wearing the HMD 110, can be detected by the position sensor 130 and/or the HMD sensor 114 mounted on the HMD 110. In FIG. 3, three-dimensional coordinates (uvw coordinates) are defined about the head of the user U wearing the HMD 110. A perpendicular direction in which the user U stands upright is defined as a v axis, a direction being orthogonal to the v axis and passing through the center of the HMD 110 is defined as a w axis, and a direction orthogonal to the v axis and the w axis is defined as a u axis. The position sensor 130 and/or the HMD sensor 114 detect(s) angles about the respective uvw axes (that is, inclinations determined by a yaw angle representing the rotation about the v axis, a pitch angle representing the rotation about the u axis, and a roll angle representing the rotation about thew axis). The control device 120 determines angular information for controlling a visual axis of the virtual camera based on the detected change in angles about the respective uvw axes.

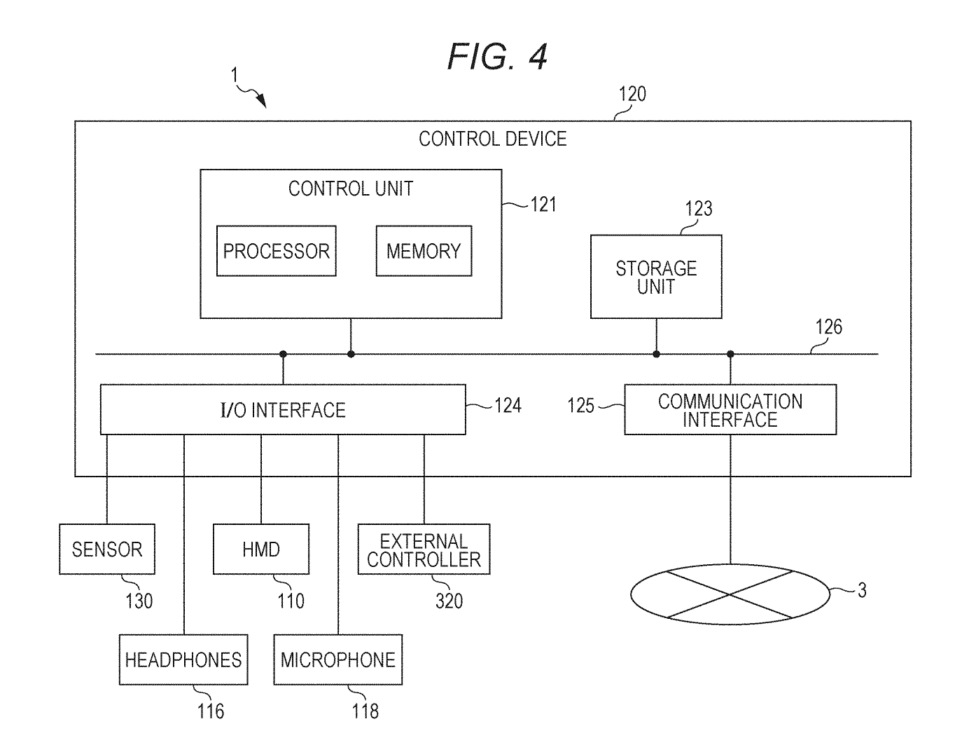

With reference to FIG. 4, a hardware configuration of the control device 120 is described. FIG. 4 is a diagram of the hardware configuration of the control device 120. In FIG. 4, the control device 120 includes a control unit 121, a storage unit 123, an input/output (I/O) interface 124, a communication interface 125, and a bus 126. The control unit 121, the storage unit 123, the I/O interface 124, and the communication interface 125 are connected to each other via the bus 126 so as to enable communication therebetween.

The control device 120 may include a personal computer, a tablet computer, or a wearable device separately from the HMD 110, or may be built into the HMD 110. A device for implementing a part of the functions of the control device 120 may be mounted to the HMD 110, and the remaining functions of the control device 120 may be performed by another device separate from the HMD 110.

The control unit 121 includes a memory and a processor. The memory is constructed of, for example, a read only memory (ROM) having various programs and the like stored therein or a random access memory (RAM) having a plurality of work areas in which various programs to be executed by the processor are stored. The processor includes, for example, a central processing unit (CPU), a micro processing unit (MPU), and/or a graphics processing unit (GPU), and is configured to load, on the RAM, programs designated by various programs installed into the ROM to execute various types of processing in cooperation with the RAM.

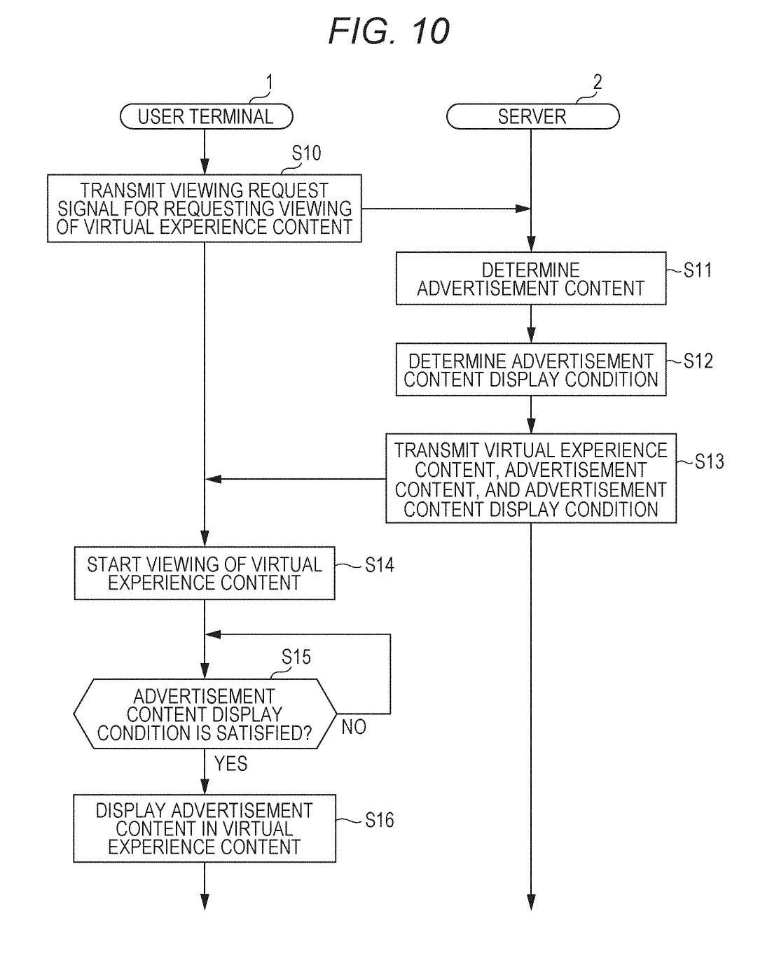

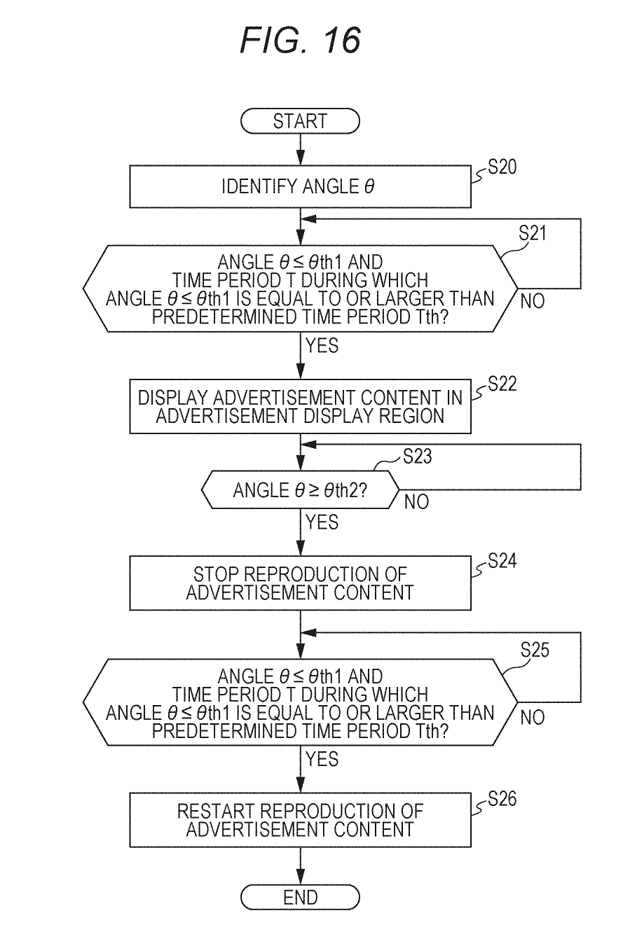

The control unit 121 may control various operations of the control device 120 by causing the processor to load a control program for executing processing, e.g., processing in FIG. 10 and FIG. 16, on the RAM to execute the control program in cooperation with the RAM. The control unit 121 displays a visual-field image of virtual experience content on the display unit 112 of the HMD 110 by reading data of the virtual experience content (virtual space) stored in the memory. This allows the user U to be immersed in the virtual experience content displayed on the display unit 112.

The storage unit (storage) 123 is a storage device, for example, a hard disk drive (HDD), a solid state drive (SSD), or a USB flash memory, and is configured to store programs and various types of data. The storage unit 123 may store a control program for executing an information processing method according to this embodiment on a computer. The storage unit 123 may store programs for authentication of the user U and data relating to various images and objects. A database including tables for managing various types of data may be constructed in the storage unit 123.

The I/O interface 124 is configured to connect each of the position sensor 130, the HMD 110, the external controller 320, the headphones 116, and the microphone 118 to the control device 120 so as to enable communication therebetween, and includes, for example, a universal serial bus (USB) terminal, a digital visual interface (DVI) terminal, or a high-definition multimedia Interface® (HDMI) terminal. The control device 120 may be wirelessly connected to each of the position sensor 130, the HMD 110, the external controller 320, the headphones 116, and the microphone 118.

The communication interface 125 is configured to connect the control device 120 to the communication network 3, for example, a local area network (LAN), a wide area network (WAN), or the Internet. The communication interface 125 includes various wire connection terminals and various processing circuits for wireless connection for communication to/from an external device, for example, the server 2, via the communication network 3, and is configured to be compatible with communication standards for communication via the communication network 3.

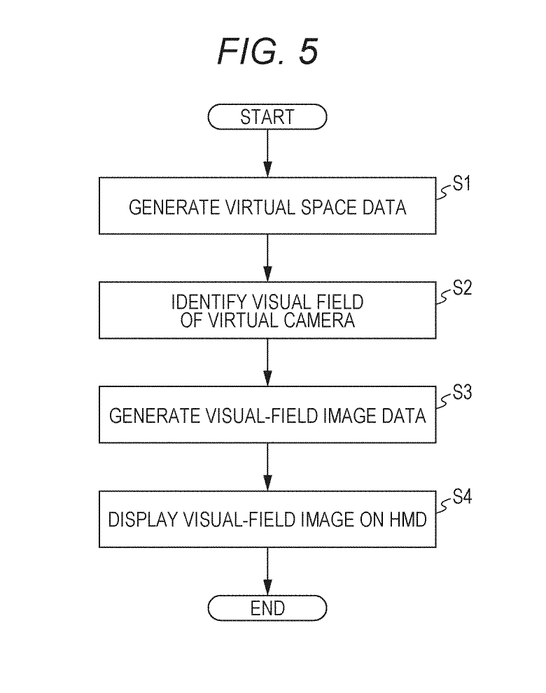

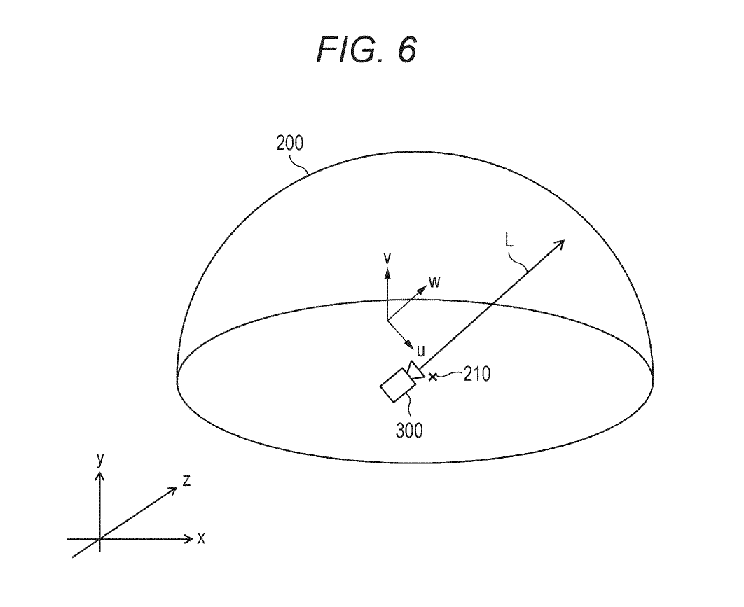

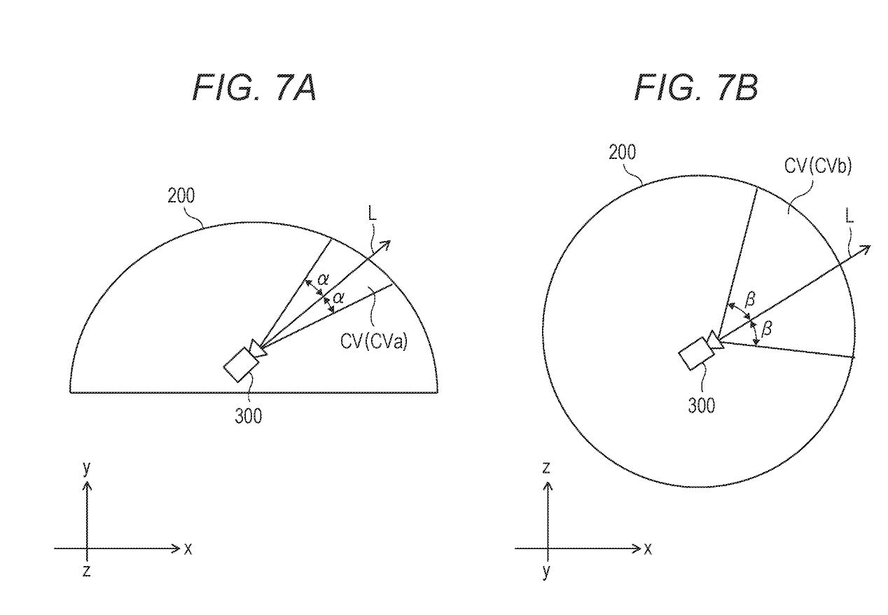

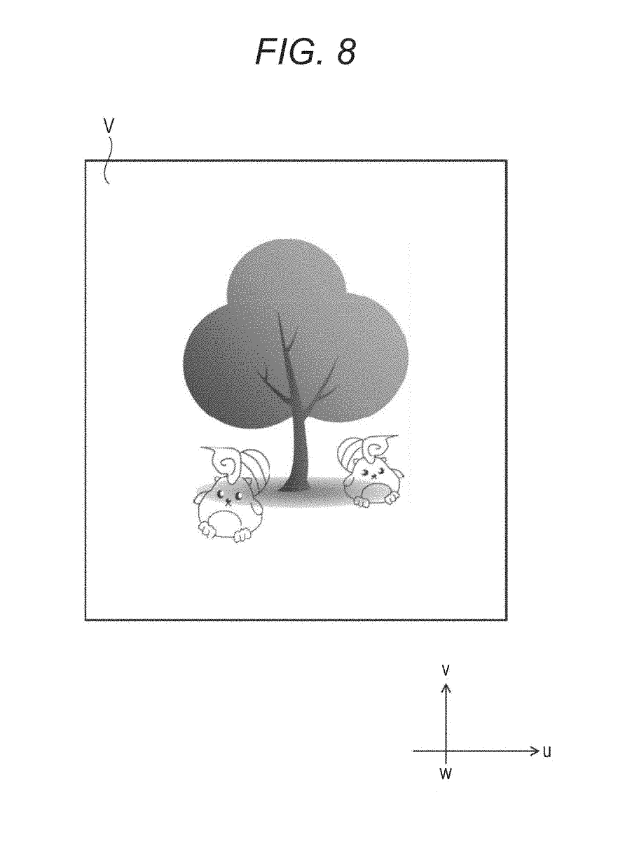

With reference to FIG. 5 to FIG. 8, processing of displaying the visual-field image on the HMD 110 is described. FIG. 5 is a flowchart of the processing of displaying the visual-field image on the HMD 110. FIG. 6 is an xyz spatial diagram of a virtual space 200. FIG. 7A is a yx plane diagram of the virtual space 200. FIG. 7B is a zx plane diagram of the virtual space 200. FIG. 8 is a diagram of a visual-field image V displayed on the HMD 110.

In FIG. 5, in Step S1, the control unit 121 (refer to FIG. 4) generates virtual space data representing the virtual space 200 including a virtual camera 300 and various objects. In FIG. 6, the virtual space 200 is defined as an entire celestial sphere having a center position 210 as the center (in FIG. 6, only the upper-half celestial sphere is included for clarity). In the virtual space 200, an xyz coordinate system having the center position 210 as the origin is set. The virtual camera 300 defines a visual axis L for identifying the visual-field image V (refer to FIG. 8) to be displayed on the HMD 110. The uvw coordinate system that defines the visual field of the virtual camera 300 is determined so as to move in association with the uvw coordinate system that is defined about the head of the user U in the real space. The control unit 121 may move the virtual camera 300 in the virtual space 200 in association with the movement in the real space of the user U wearing the HMD 110.

In Step S2, the control unit 121 identifies a visual field CV (refer to FIG. 7) of the virtual camera 300. Specifically, the control unit 121 acquires information relating to a position and an inclination of the HMD 110 based on data representing the state of the HMD 110, which is transmitted from the position sensor 130 and/or the HMD sensor 114. The control unit 121 identifies the position and the direction of the virtual camera 300 in the virtual space 200 based on the information relating to the position and the inclination of the HMD 110. The control unit 121 determines the visual axis L of the virtual camera 300 based on the position and the direction of the virtual camera 300, and identifies the visual field CV of the virtual camera 300 based on the determined visual axis L. The visual field CV of the virtual camera 300 corresponds to a part of the region of the virtual space 200 that can be visually recognized by the user U wearing the HMD 110 (in other words, corresponds to a part of the region of the virtual space 200 to be displayed on the HMD 110). The visual field CV has a first region CVa set as an angular range of a polar angle α about the visual axis L in the xy plane in FIG. 7A, and a second region CVb set as an angular range of an azimuth β about the visual axis L in the xz plane in FIG. 7B. The control unit 121 may identify the line-of-sight direction of the user U based on data representing the line-of-sight direction of the user U, which is transmitted from the eye gaze sensor 140, and may determine the direction of the virtual camera 300 based on the line-of-sight direction of the user U.

The control unit 121 can identify the visual field CV of the virtual camera 300 based on the data transmitted from the position sensor 130 and/or the HMD sensor 114. When the user U wearing the HMD 110 moves, the control unit 121 can change the visual field CV of the virtual camera 300 based on the data representing the motion of the HMD 110, which is transmitted from the position sensor 130 and/or the HMD sensor 114. That is, the control unit 121 can change the visual field CV in accordance with the motion of the HMD 110. Similarly, when the line-of-sight direction of the user U changes, the control unit 121 may move the visual field CV of the virtual camera 300 based on the data representing the line-of-sight direction of the user U, which is transmitted from the eye gaze sensor 140. That is, the control unit 121 may change the visual field CV in accordance with the change in the line-of-sight direction of the user U.

In Step S3, the control unit 121 generates visual-field image data representing the visual-field image V to be displayed on the display unit 112 of the HMD 110. Specifically, the control unit 121 generates the visual-field image data based on the virtual space data for defining the virtual space 200 and the visual field CV of the virtual camera 300.

In Step S4, the control unit 121 displays the visual-field image V on the display unit 112 of the HMD 110 based on the visual-field image data (refer to FIG. 7A and FIG. 7B). The visual field CV of the virtual camera 300 changes in accordance with the motion of the user U wearing the HMD 110, and hence the visual-field image V to be displayed on the display unit 112 of the HMD 110 changes as well. Thus, the user U can be immersed in the virtual space 200.

The virtual camera 300 may include a left-eye virtual camera and a right-eye virtual camera. In this case, the control unit 121 generates left-eye visual-field image data representing a left-eye visual-field image based on the virtual space data and the visual field of the left-eye virtual camera. The control unit 121 generates right-eye visual-field image data representing a right-eye visual-field image based on the virtual space data and the visual field of the right-eye virtual camera. Afterwards, the control unit 121 displays the left-eye visual-field image on a left-eye display unit based on the left-eye visual-field image data, and displays the right-eye visual-field image on a right-eye display unit based on the right-eye visual-field image data. In this manner, the user U can visually recognize the visual-field image three-dimensionally owing to parallax between the left-eye visual-field image and the right-eye visual-field image. For the sake of convenience of description, an arrangement with one virtual camera 300 is described. In at least one embodiment of this disclosure, the arrangement includes multiple virtual cameras.

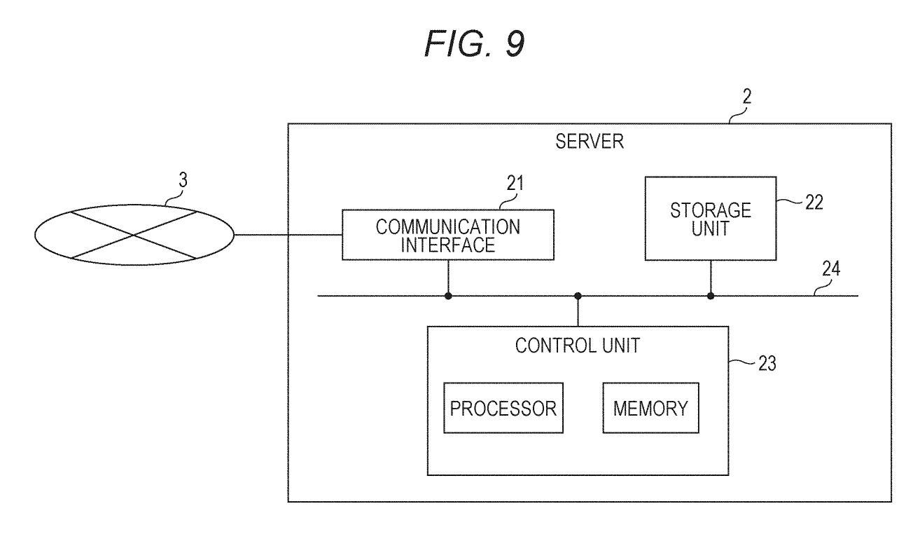

A hardware configuration of the server 2 in FIG. 1 is described with reference to FIG. 9. FIG. 9 is a diagram of the hardware configuration of the server 2. In FIG. 9, the server 2 includes a control unit 23, a storage unit 22, a communication interface 21, and a bus 24. The control unit 23, the storage unit 22, and the communication interface 21 are connected to one another through the bus 24 so as to enable communication therebetween. The control unit 23 includes a memory and a processor. The memory is constructed of, for example, a ROM and a RAM, and the processor is constructed of, for example, a CPU, an MPU and/or a GPU.

The storage unit (storage) 22 is, for example, a large capacity HDD, which is configured to store a control program for executing processing, e.g., processing in FIG. 10, and virtual experience content. The communication interface 21 is configured to connect the server 2 to the communication network 3.

Now, with reference to FIG. 10, a description is given of an operation of the distribution system 100 in at least one embodiment. FIG. 10 is a sequence diagram of an operation of the distribution system 100. In FIG. 10, in Step S10, the user U wearing the HMD performs a predetermined operation for starting viewing of virtual experience content (virtual space). The control unit 121 of the user terminal 1 transmits, to the server 2 via the communication network 3, a viewing request signal representing a virtual experience content request for requesting viewing of virtual experience content in response to the predetermined operation performed by the user U. The viewing request signal may include address information (IP address of user terminal 1 and IP address of server 2) and ID information on the user U. The control unit 23 of the server 2 receives the viewing request signal from the user terminal 1, and then determines advertisement content (sub-content) displayed in virtual experience content (Step S11). For example, the control unit 23 may determine advertisement content to be displayed, based on advertisement effects. An advertisement effect is related to an interest level in the advertisement and a cost of the advertisement. Alternatively, the control unit 23 may determine advertisement content to be displayed, based on attributes (e.g., size, shape, and position) of advertisement content objects (sub-content) included in virtual experience content (or virtual space forming virtual experience content). Alternatively, the control unit 23 may determine advertisement content to be displayed, based on both of the advertisement effects and the attributes of advertisement content objects. The advertisement content is an advertisement image. The advertisement image may be displayed, for example, as an advertisement banner or may indicate a link. The advertisement image may be an advertisement video. The advertisement image may be displayed three-dimensionally.

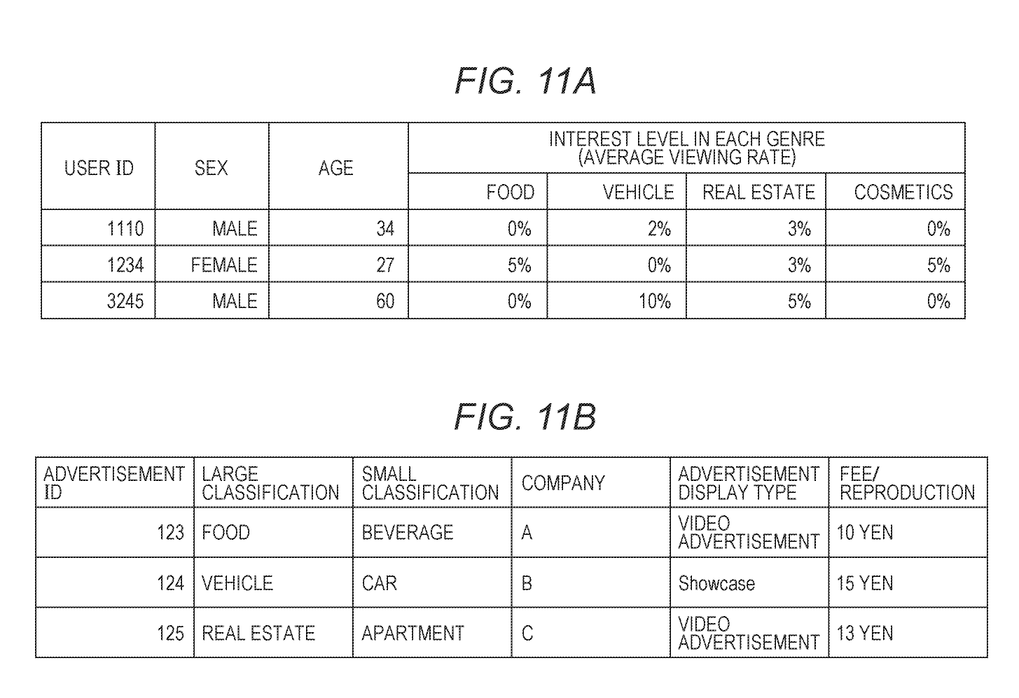

Now, with reference to FIG. 11A and FIG. 11B, a description is given of an example of a technique of determining advertisement content based on advertisement effects. FIG. 11A is a diagram of an advertisement interest level table for showing an interest level of each user in each advertisement content (genre). FIG. 11B is a diagram of an advertisement attribute table for showing an attribute of each advertisement. The advertisement interest level table and the advertisement attribute table may be stored in the storage unit 22 of the server 2. The server 2 may update content (interest level in each genre) of the advertisement interest level table by acquiring data from a plurality of user terminals connected to the server 2 via the communication network 3. The control unit 23 of the server 2 identifies advertisement content having the highest advertisement effect for the user U based on the ID information on the user U (user U's ID: 1110) included in the transmitted viewing request signal, the advertisement interest level table, and the advertisement attribute table. Specifically, the control unit 23 identifies the ID information on the user U, and then identifies advertisement content having the highest advertisement effect based on the interest level (average viewing rate) of the user U in each genre and a fee per reproduction of each advertisement.

For example, an advertisement effect of an apartment advertisement by a company C on the user U (user ID: 1110) can be calculated in the following manner.

Advertisement effect=(interest level of user U in real estate: 3%)×(fee per reproduction: 13 yen/reproduction)=39 points

An advertisement effect of a car advertisement by a company B on the user U (user ID: 1110) can be calculated in the following manner.

Advertisement effect=(interest level of user U in vehicle: 2%)×(fee per reproduction: 15 yen/reproduction)=30 points

In the example described above, (advertisement effect of apartment advertisement by company C: 39 points)>(advertisement effect of automobile advertisement by company B: 30 points) is obtained for the user U, and thus the control unit 23 refers to the advertisement interest level table and the advertisement attribute table to determine content of the apartment advertisement by the company C as advertisement content to be displayed.

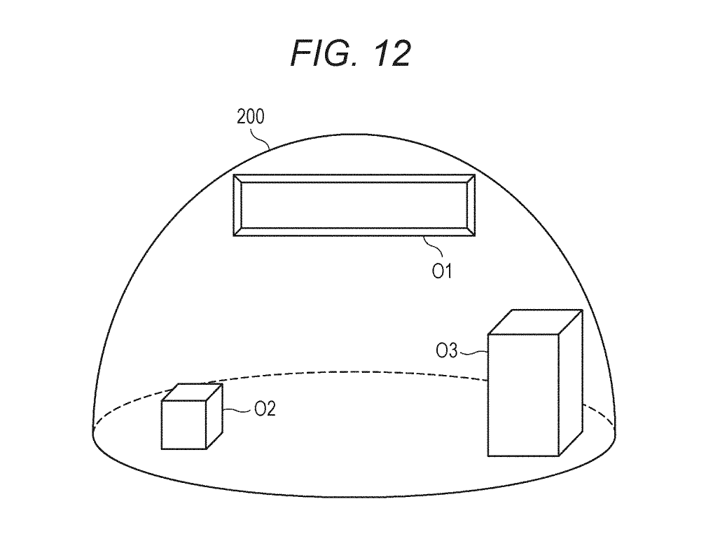

Now, with reference to FIG. 12, a description is given of a technique of determining advertisement content based on the attributes of advertisement content objects. FIG. 12 is a diagram of advertisement content objects O1 to O3 arranged in the virtual space 200 forming the advertisement content. Each of the advertisement content objects O1 to O3 includes an advertisement content display region (sub-content display region) for displaying the advertisement content. When the advertisement content is displayed two-dimensionally (namely, when the advertisement content is a two-dimensional image), the advertisement content may be displayed on each of the surfaces of the advertisement content objects O1 to O3. In this case, the advertisement content display region is formed on each of the surfaces of the advertisement content objects O1 to O3. When the advertisement content is displayed three-dimensionally, the advertisement content may be displayed inside each of the advertisement content objects O1 to O3. In this case, the advertisement content display region is formed inside each of the advertisement content objects O1 to O3. The advertisement content objects O1 to O3 may be transparent (namely, texture mapping processing is not executed for each advertisement content object).

When the advertisement content object included in the virtual experience content to be transmitted to the user terminal 1 is the advertisement content object O1, the control unit 23 of the server 2 determines advertisement content to be displayed as the virtual experience content based on attributes (e.g., size, position, and shape) of the advertisement content object O1. For example, when the control unit 23 determines that the image size of advertisement content (in this example, apartment advertisement) having the highest advertisement effect exceeds the frame of the advertisement content object O1, the control unit 23 determines whether or not the image size of advertisement content (in this example, car advertisement) having the second highest advertisement effect is smaller than the frame of the advertisement content object O1. When the control unit 23 determines that the car advertisement is smaller than the frame of the advertisement content object O1, the control unit 23 determines the car advertisement as advertisement content to be displayed.

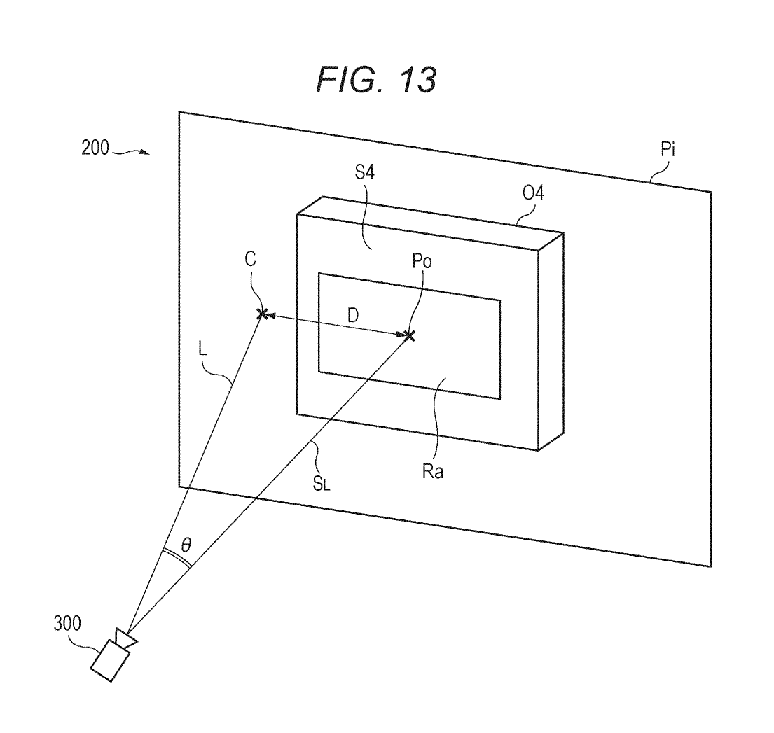

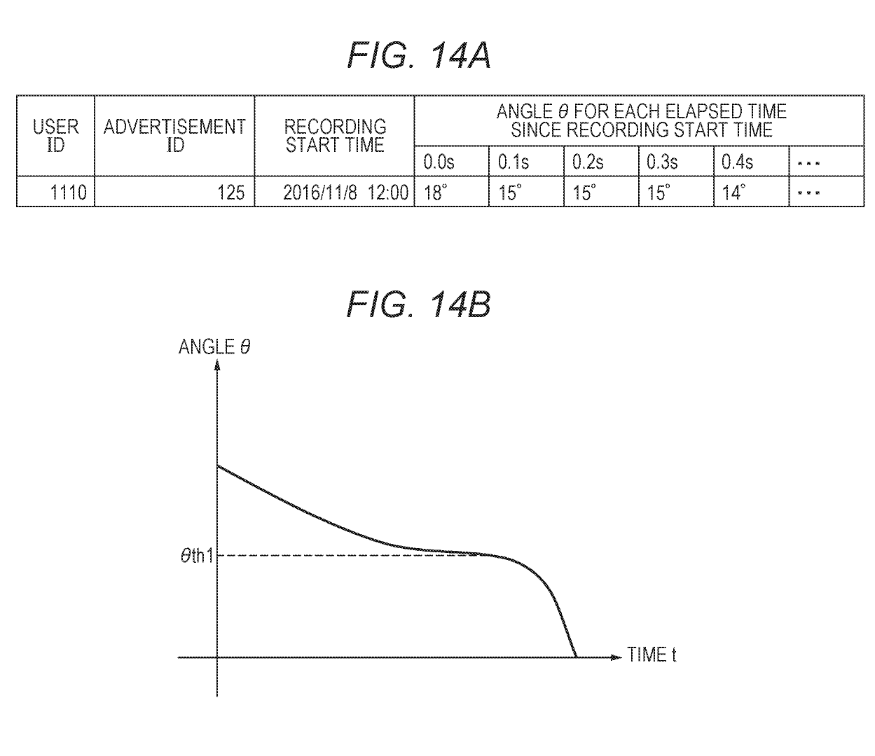

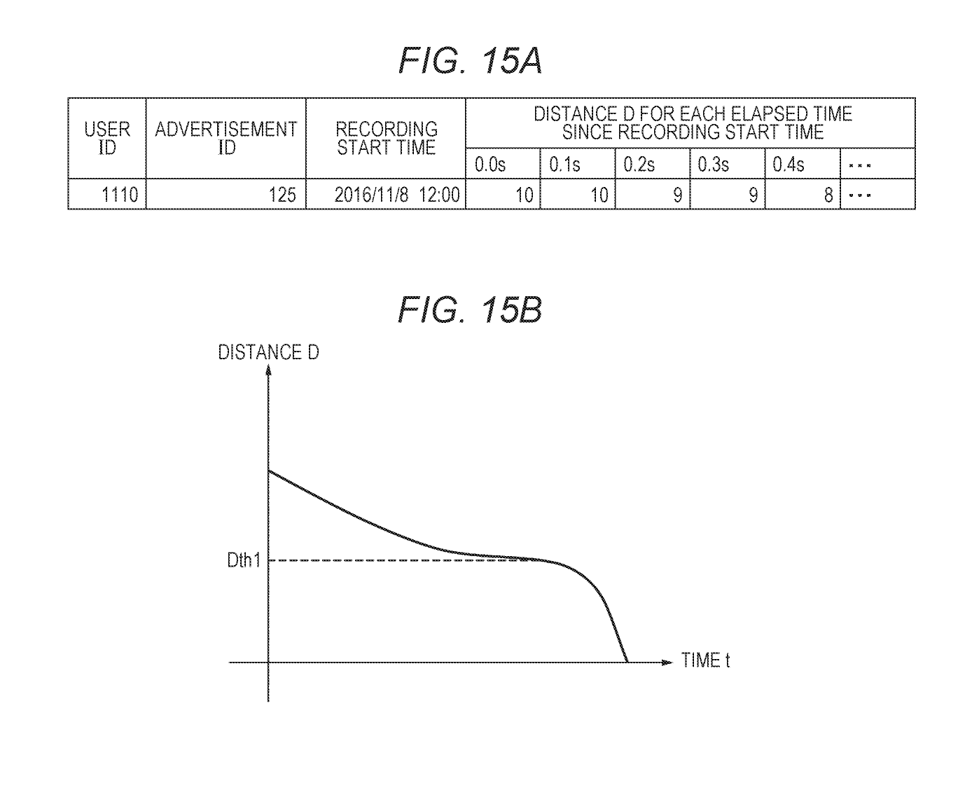

Referring back to FIG. 10, the control unit 23 determines an advertisement content display condition (sub-content display condition) that defines a timing to display the advertisement content (Step S12). In the following, with reference to FIG. 13 to FIG. 15B, a description is given of a technique of determining the advertisement content display condition. With reference to FIG. 13, FIG. 14A and FIG. 14B, a description is given of an example of determining the advertisement content display condition that uses the angle θ. With reference to FIG. 13, FIG. 15A and FIG. 15B, a description is given of an example of determining the advertisement content display condition that uses the distance D. When the advertisement content is a still image, the “advertisement content display condition” represents a condition that defines a timing to display an advertisement image. Meanwhile, when the advertisement content is a moving image, the “advertisement content display condition” represents both of the condition that defines a timing to display an advertisement video and a condition that defines a start of reproduction of an advertisement video.

FIG. 13 is a diagram of a relative positional relationship (between angle θ and distance D) between a visual axis L of the virtual camera 300 and an advertisement content display region Ra. FIG. 14A is a diagram of first line-of-sight information data representing a relationship between the elapsed time t since a recording start time and the angle θ. FIG. 14B is a graph of the relationship between the elapsed time t and the angle θ. FIG. 15A is a diagram of second line-of-sight information data representing a relationship between the elapsed time t since a recording start time and the distance D. FIG. 15B is a graph of the relationship between the elapsed time t and the distance D.

<Advertisement Content Display Condition that Uses Angle θ>

In FIG. 13, an advertisement content object O4 is arranged in the virtual space 200 forming the virtual experience content, and the advertisement content display region Ra is set on a surface S4 of the advertisement content object O4. In this description, the advertisement content displayed on the advertisement content display region Ra is an image displayed two-dimensionally in the virtual space (namely, two-dimensional image) and the advertisement content display condition represents a condition that defines a timing to display the two-dimensional image.

The advertisement content display condition includes a first condition related to the angle θ (example of relative positional relationship) between the visual axis L of the virtual camera 300, which operates in synchronization with motion of the HMD 110, and the advertisement content display region Ra, and includes a second condition related to a time period T. The first condition is related to the angle θ formed by the visual axis L of the virtual camera 300 and a line segment SL connecting between a center position P0 (example of predetermined position) of the advertisement content display region Ra and the virtual camera 300 (e.g., center of virtual camera 300). Specifically, the first condition is a condition for determining whether or not the angle θ is equal to or smaller than a first threshold angle θth1.

In the following, a description is given of an example of a method of determining the first condition related to the first threshold angle θth1. The control unit 23 of the server 2 acquires the first line-of-sight information data representing a relationship between the elapsed time t and the angle θ from the user terminal 1 before the processing of Step S10 in FIG. 10, and then stores the acquired first line-of-sight information data into the storage unit 22. The first line-of-sight information data is line-of-sight information data related to the user U and an apartment advertisement of the company C (advertisement ID: 125). In Step S12 in FIG. 10, the control unit 23 determines the first threshold angle θth1 based on the first line-of-sight information data acquired from the user terminal 1. For example, when the first line-of-sight information data has a relationship in FIG. 14B, the control unit 23 may determine, as the first threshold angle θth1, the angle (Δθ/Δt=0) having a zero first derivative with respect to the time t. Alternatively, the control unit 23 may determine, as the first threshold angle θth1, the angle having a minimum (Δθ/Δt) (<0). Alternatively, the control unit 23 may determine the first threshold angle θth1 based on the first line-of-sight information data and another predetermined data analysis algorithm. After determining the first threshold angle θth1, the control unit 23 can determine whether or not the angle θ is equal to or smaller than the first threshold angle θth1.

The control unit 23 determines the second condition related to time. Specifically, the control unit 23 determines a time condition (T≥Tth) for determining whether or not the time period T during which the angle θ is equal to or smaller than the first threshold angle θth1 is equal to or larger than a predetermined time period Tth. The predetermined time period Tth may be determined depending on attributes (for example, sex or age) of the user or may be determined depending on attributes of the advertisement content. In other cases, the predetermined time period Tth may be any time period (e.g., 1 second) that is independent of the attributes of the user or advertisement content.

The control unit 23 can determine the advertisement content display condition that uses the angle θ and includes the first condition (θ≤θth1) related to the angle θ and the second condition (T≥Tth) related to the time period T. In at least one embodiment, the advertisement content display condition that uses the angle θ may include only the first condition (00th1).

<Advertisement Content Display Condition that Uses Distance D>

In the following, with reference to FIG. 13, FIG. 15A and FIG. 15B, a description is given of the advertisement content display condition that uses the distance D. The advertisement content display condition includes a first condition related to the distance D (example of relative positional relationship) between the visual axis L of the virtual camera 300, which operates in synchronization with motion of the HMD 110, and the advertisement content display region Ra, and includes a second condition related to the time period T. The first condition is related to the distance D between the center position P0 of the advertisement content display region Ra and the intersection C between a virtual plane Pi and the visual axis L of the virtual camera 300. Specifically, the first condition is a condition for determining whether or not the distance D is equal to or smaller than a first threshold distance Dth1. The virtual plane Pi is a virtual plane including the advertisement content display region Ra and parallel to the advertisement content display region Ra.

Now, a description is given of an example of a method of determining the first condition related to the first threshold distance Dth1.

The control unit 23 of the server 2 acquires the second line-of-sight information data representing a relationship between the elapsed time t and the distance D from the user terminal 1 before the processing of Step S10 in FIG. 10, and then stores the acquired second line-of-sight information data into the storage unit 22. The second line-of-sight information data is line-of-sight information data related to the user U and an apartment advertisement of the company C (advertisement ID: 125). In Step S12 in FIG. 10, the control unit 23 determines the first threshold distance Dth1 based on the second line-of-sight information data acquired from the user terminal 1. For example, when the second line-of-sight information data has a relationship in FIG. 15B, the control unit 23 may determine, as the second threshold distance Dth1, the distance (ΔD/Δt=0) having a zero first derivative with respect to the time t. Alternatively, the control unit 23 may determine, as the first threshold distance Dth1, the distance having a minimum (ΔD/Δt) (<0). Alternatively, the control unit 23 may determine the first threshold distance Dth1 based on the second line-of-sight information data and a predetermined data analysis algorithm. The control unit 23 can determine whether or not the distance D is equal to or smaller than the first threshold distance Dth1.

The control unit 23 determines the second condition related to the time period T. Specifically, the control unit 23 determines a time condition (T≥Tth) for determining whether or not the time period T during which the distance D is equal to or smaller than the first threshold distance Dth1 is equal to or larger than the predetermined time period Tth. The predetermined time period Tth may be determined depending on attributes (for example, sex or age) of the user or may be determined depending on attributes of the advertisement content. In other cases, the predetermined time period Tth may be anytime period (e.g., 1 second) that is independent of the attributes of the user or advertisement content.

The control unit 23 can determine the advertisement content display condition that uses the distance D and includes the first condition (D≤Dth1) related to the distance D and the second condition (T≥Tth) related to the time period T. In at least one embodiment, the advertisement content display condition that uses the distance D may include only the first condition (D≤Dth1).

Referring back to FIG. 10, the control unit 23 determines the advertisement content display condition, and then transmits, to the user terminal 1, virtual experience content data, advertisement content data, and the advertisement content display condition (e.g., advertisement content display condition that uses the angle θ) (Step S13). After that, in Step S14, the control unit 121 of the user terminal 1 receives the virtual experience content data, the advertisement content data, and the advertisement content display condition, and then displays a visual-field image of the virtual experience content on the HMD 110. In this manner, the user U can start viewing of the virtual experience content. As already described with reference to FIG. 5, the visual-field image of the virtual experience content is updated depending on motion (position and inclination) of the HMD 110.

The control unit 121 determines whether or not the advertisement content display condition is satisfied (Step S15). When the control unit 121 determines that the advertisement content display condition is satisfied (YES in Step S15), the control unit 121 displays the advertisement content in virtual experience content (Step S16). On the contrary, when the control unit 121 determines that the advertisement content display condition is not satisfied (NO in Step S15), the processing returns to Step S15 again.

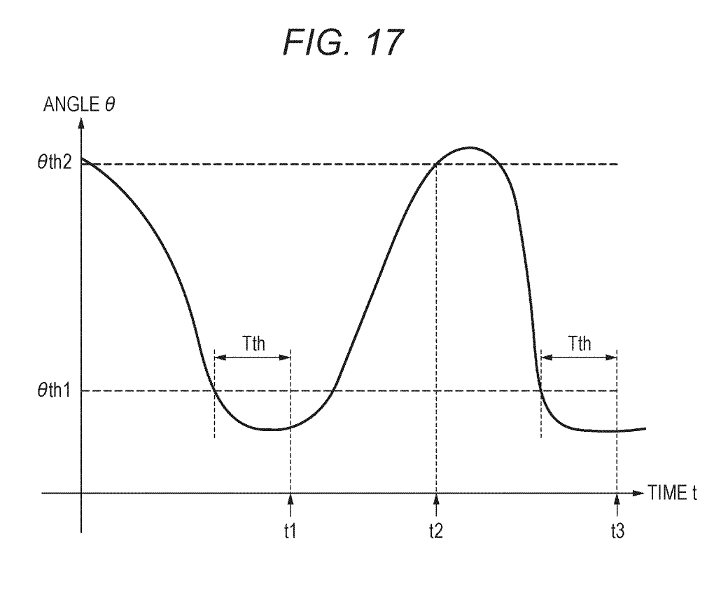

Now, with reference to FIG. 16 and FIG. 17, a specific description is given of Step S15 and Step S16 in FIG. 10. In the following description, the advertisement content display condition is an advertisement content display condition that uses the angle θ, and includes the first condition (θ≤θth1) and the second condition (T≥Tth). In the following description, the advertisement content is a moving image. FIG. 16 is a flowchart of the advertisement content display condition that uses the angle θ. FIG. 17 is a graph of a relationship between the angle θ and the elapsed time t of the advertisement content display condition.

The control unit 121 identifies the angle θ formed by the visual axis L of the virtual camera 300 and the line segment SL (Step S20). The control unit 121 determines, as the advertisement content display condition, whether or not the angle θ is equal to or smaller than the first threshold angle θth1 (first condition) and determines whether or not the time period T during which the angle θ is equal to or smaller than the first threshold angle θth1 is equal to or larger than the predetermined time period Tth (e.g., 1 second) (second condition) (Step S21).

When the control unit 121 determines that the advertisement content display condition defined in Step S21 is satisfied (YES in Step S21), the control unit 121 displays the advertisement content on the advertisement content display region Ra and starts reproduction of the advertisement content at a time t1 (refer to FIG. 17) (Step S22). On the contrary, when the control unit 121 determines that the advertisement content display condition defined in Step S21 is not satisfied (NO in Step S21), the control unit 121 executes the processing of Step S21 again. The advertisement content may be displayed on the advertisement content display region Ra before the processing of Step S21. Under this state, in Step S22, the control unit 121 may start reproduction of the advertisement content displayed on the advertisement content display region Ra. When the advertisement content is a still image, in Step S22, the control unit 121 may display the advertisement content on the advertisement content display region Ra.

The control unit 121 determines whether or not the angle θ is equal to or larger than a second threshold angle θth2 (Step S23). When the control unit 121 determines that the angle θ is equal to or larger than the second threshold angle θth2 (YES in Step S23), the control unit 121 stops reproduction of the advertisement content at a time t2 (refer to FIG. 17) (Step S24). On the contrary, when it is determined that the angle θ is equal to or smaller than the second threshold angle θth2 (NO in Step S23), the processing of Step S23 is executed again. In Step S24, the control unit 121 may hide the advertisement content displayed on the advertisement content display region. When the advertisement content is a still image, as shown in FIG. 17, the advertisement content is displayed at the time t1, and the advertisement content displayed on the advertisement content display region Ra is hidden at the time t2. In at least one embodiment, the second threshold angle θth2 is larger than the first threshold angle θth1. The advertisement content reproduction stop condition (θ≥th2) defined in Step S23 may be determined by the server 2 based on the first line-of-sight information data and transmitted to the user terminal 1 from the server 2.

After the processing of Step S24 is executed, the control unit 121 determines whether or not the angle θ is equal to or smaller than the first threshold angle θth1 (first condition) and determines whether or not the time period T during which the angle θ is equal to or smaller than the first threshold angle θth1 is equal to or larger than the predetermined time period Tth (e.g., 1 second) (second condition) (Step S25). When the control unit 121 determines that the advertisement content display condition defined in Step S25 is satisfied (YES in Step S25), the control unit 121 restarts reproduction of the advertisement content at a time t3 (refer to FIG. 17) (Step S26). On the contrary, when the control unit 121 determines that the advertisement content display condition defined in Step S25 is not satisfied (NO in Step S25), the control unit 121 executes the processing of Step S25 again. In Step S26, the control unit 121 may start reproduction of the advertisement content from the beginning. When the advertisement content is a still image, the control unit 121 may display the advertisement content on the advertisement content display region Ra again at the time t3.

In at least one embodiment, the advertisement content display condition defined in Step S21 and Step S25 may include only the condition for determining whether or not the angle θ is equal to or smaller than the first threshold angle θth1. In at least one embodiment, the advertisement content display condition defined in Step S21 and Step S25 may be an advertisement content display condition that uses the distance D instead of the advertisement content display condition that uses the angle θ. In this case, the advertisement content display condition defined in Step S21 and Step S25 includes a first condition for determining whether or not the distance D is equal to or smaller than the first threshold distance Dth1 (first condition) and a second condition for determining whether or not the time period T during which the distance D is equal to or smaller than the first threshold distance Dth1 is equal to or larger than the predetermined time period Tth (e.g., 1 second). The advertisement content reproduction stop condition defined in Step S23 is a condition for determining whether or not the distance D is equal to or larger than the second threshold distance Dth2 (D≥Dth2). The advertisement content display condition defined in Step S21 and Step S25 may include only the first condition for determining whether or not the distance D is equal to or smaller than the first threshold distance Dth1 (first condition). The second threshold distance Dth2 is larger than the first threshold distance Dth1. The advertisement content reproduction stop condition (D≥Dth2) defined in Step S23 may be determined by the server 2 based on the second line-of-sight information data and transmitted to the user terminal 1 from the server 2.

According to at least one embodiment, the advertisement content display condition that defines the timing to display advertisement content is determined, and the virtual experience content data, the advertisement content data, and the advertisement content display condition are transmitted to the user terminal 1. The advertisement content can be displayed in the virtual experience content at an optimal timing based on the advertisement content display condition. Therefore, the information processing method is capable of enhancing an advertisement effect of the virtual experience content.

In response to a determination that the relative positional relationship (e.g., with respect to angle θ) between the visual axis L of the virtual camera 300 and the advertisement content display region Ra satisfies the first condition (e.g., θ≤θth1) and this determination results in a determination that the relative positional relationship satisfies the first condition, the advertisement content is displayed in the virtual experience content. Therefore, the advertisement content is displayed in the virtual experience content at an optimal timing.

According to at least one embodiment, the first condition related to the first threshold angle θth1 is determined based on the first line-of-sight information data acquired from the user terminal 1. The first condition related to the first threshold distance Dth1 is determined based on the second line-of-sight information data acquired from the user terminal 1. The advertisement content in the virtual experience content is displayed at a more optimal timing by utilizing the first or second line-of-sight information data (big data).

According to at least one embodiment, the advertisement content displayed in the virtual experience content is determined based on attributes of the advertisement content object, and thus advertisement content most suitable for the advertisement content object is displayed.

In order to implement various types of processing to be executed by the control unit 23 of the server 2 (or the control unit 121 of the user terminal 1) with use of software, a control program for executing the information processing method according to this embodiment on a computer (processor) may be installed in advance into the storage unit 22 (or the storage unit 123) or a ROM. Alternatively, the control program may be stored in a computer-readable storage medium, for example, a magnetic disk (HDD or floppy disk), an optical disc (for example, CD-ROM, DVD-ROM, or Blu-ray disc), a magneto-optical disk (for example, MO), and a flash memory (for example, SD card, USB memory, or SSD). In this case, when the storage medium is connected to the server 2 (or the control device 120), the program stored in the storage medium is installed into the storage unit 22 (or the storage unit 123). Then, the control program installed in the storage unit 22 (or the storage unit 123) is loaded onto the RAM, and the processor executes the loaded program. In this manner, the control unit 23 (or the control unit 121) executes the information processing method according to at least one embodiment.

The control program may be downloaded from a computer on the communication network 3 via the communication interface. Also in this case, the downloaded program is similarly installed into the storage unit 22 (or the storage unit 123).

This concludes description of embodiments of this disclosure. However, the description of embodiments is not to be read as a restrictive interpretation of the technical scope of this disclosure. The embodiments are merely given as an example, and is to be understood by a person skilled in the art to permit various modifications within the scope of this disclosure set forth in the appended claims. Thus, the technical scope of this disclosure is to be defined based on the scope of this disclosure set forth in the appended claims and an equivalent scope thereof.

In the description of at least embodiment, as in FIG. 13, the advertisement content display region Ra for displaying the advertisement content is formed on the surface S4 of the advertisement content object O4. However, the advertisement content display region Ra may be formed on the surface of the celestial virtual space 200. When the virtual experience content is constructed as the virtual space including a 360 degree image, the advertisement content display region Ra is formed on the surface of the virtual space 200 in which the 360 degree image is displayed, in at least one embodiment. In this case, the advertisement content display condition may be an advertisement content display condition that uses the angle θ and includes the first condition (θ≤th1) related to the angle θ and the second condition (T≥Tth) related to the time period T.

[Supplementary Notes]

(1) An information processing method is executed by a processor in a virtual experience content distribution system including a user terminal and a server. The user terminal includes a head-mounted device, which is mountable on a head of a user, and is configured to display a visual-field image of virtual experience content. The information processing method includes receiving a virtual experience content request for requesting the virtual experience content from the user terminal. The method further includes determining sub-content to be displayed in the virtual experience content. The method further includes determining a sub-content display condition that defines a timing to display the sub-content. The method further includes transmitting data on the virtual experience content, data on the sub-content, and the sub-content display condition to the user terminal.

According to the method described above, the sub-content display condition that defines the timing to display the sub-content is determined, and the data on the virtual experience content, the data on the sub-content, and the sub-content display condition are transmitted to the user terminal. The sub-content can be displayed in the virtual experience content at an optimal timing based on the sub-content display condition. Therefore, the information processing method is capable of enhancing an advertisement effect of the virtual experience content.

(2) An information processing method according to Item (1), in which the visual-field image of the virtual experience content is updated in synchronization with motion of the head-mounted device. The sub-content display condition includes a first condition related to a relative positional relationship between a visual axis of a virtual camera, which is configured to move in synchronization with motion of the head-mounted device, and a sub-content display region for displaying the sub-content.

According to the method described above, the sub-content in the virtual experience content is displayed at an optimal timing based on a relative positional relationship between the visual axis of the virtual camera and the sub-content display region.

(3) An information processing method according to Item (2), further including acquiring, from the user terminal, line-of-sight information data representing a relationship between the relative positional relationship and an elapsed time for the user. The determining of the sub-content display condition includes determining the first condition based on the line-of-sight information data.

According to the method described above, the first condition is determined based on the line-of-sight information data acquired from the user terminal. The sub-content is displayed in the virtual experience content at a more optimal timing by utilizing the line-of-sight information data.

(4) An information processing method according to Item (2) or (3), further including determining whether or not the relative positional relationship satisfies the first condition. The method further includes displaying the sub-content in the virtual experience content when the relative positional relationship is determined to satisfy the first condition.

According to the method described above, in response to a determination that the relative positional relationship between the visual axis of the virtual camera and the sub-content display region satisfies the first condition, and the relative positional relationship is determined to satisfy the first condition, sub-content is displayed in the virtual experience content. The sub-content is displayed in the virtual experience content at an optimal timing.

(5) An information processing method according to any one of Items (2) to (4), in which the relative positional relationship is an angle formed by the visual axis of the virtual camera and a line segment connecting between a predetermined position of the sub-content display region and the virtual camera.

According to the method described above, the sub-content is displayed in the virtual experience content at an optimal timing based on the angle formed by the visual axis of the virtual camera and the line segment connecting between the predetermined position of the sub-content display region and the virtual camera.

(6) An information processing method according to any one of Items (2) to (4), in which the relative positional relationship is a distance between a predetermined position of the sub-content display region and an intersection between a virtual plane including the sub-content display region and the visual axis of the virtual camera.

According to the method described above, the sub-content is displayed in the virtual experience content at an optimal timing based on the distance between the predetermined position of the sub-content display region and the intersection between the virtual plane including the sub-content display region and the visual axis of the virtual camera.

(7) An information processing method according to any one of Items (1) to (6), in which the virtual experience content includes a sub-content object including a sub-content display region for displaying the sub-content. The determining of the sub-content includes determining sub-content to be displayed in the virtual experience content based on an attribute of the sub-content object.

According to the method described above, the sub-content to be displayed in the virtual experience content is identified based on the attribute of the sub-content object, and thus the sub-content most suitable for the sub-content object is displayed.

1-10. (canceled)

11. A method, comprising:
receiving a signal requesting content, wherein the content defines a virtual space displayable on a head mounted display (HMD);
determining sub-content to be displayed in the virtual space;
determining a display condition, wherein the display condition defines a timing for displaying the sub-content in the virtual space; and
instructing a user terminal including the HMD to display the content and the sub-content based on the determined display condition.

12. The method according to claim 11, further comprising:
determining a location of a virtual camera in the virtual space, wherein a visual-field image displayed by the HMD is based on the location of the virtual camera;
moving the virtual camera in the virtual spaced in response to a detected movement of the HMD.

13. The method according to claim 12, wherein the determining of the display condition includes determining the display condition based on a first condition defining a relative positional relationship between a visual axis of the virtual camera and a display region of the sub-content.

14. The method according to claim 13, wherein the determining of the display condition includes determining the display condition based on a second condition defining a time period during which the relative positional relationship is continuously satisfied.

15. The method according to claim 11, further comprising:
identifying an attribute of a user associated with the user terminal,
wherein the determining of the display condition includes determining the display condition based on the attribute of the user.

16. The method according to claim 15, further comprising:
storing history data identifying one of a plurality of pieces of the content displayed on the HMD; and
determining an interest level of the user based on the history data,
wherein the identifying the attribute of the user comprises identifying the attribute of the user based on the determined interest level.

17. The method according to claim 11, wherein the determining of the display condition comprises determining the display condition based on an attribute of the sub-content.

18. The method according to claim 12, wherein the relative positional relationship comprises an angle between a visual axis of the virtual camera and a line segment connecting a center position of a display region of the sub-content and a position of the virtual camera.

19. The method according to claim 12, wherein the relative positional relationship comprises a distance between a position of a display region of the sub-content and an intersection between a visual axis of the virtual camera and a virtual plane including the position of the display region.

20. The method according to claim 11, wherein the virtual space includes a display region for displaying the sub-content and an object for defining a type of the sub-content for display in the virtual space.

21. The method according to claim 20, wherein the mode of display applicable to the sub-content is defined in advance.

22. The method according to claim 20, wherein the determining of the sub-content comprises selecting the sub-content from a group of pieces of sub-content based on the object.

23. The method according to claim 20, further comprising identifying the object included in the visual-field image,
wherein the identifying of the group of pieces of sub-content includes identifying the group of pieces of sub-content capable of being displayed on the identified object, and
wherein the identifying the object includes identifying the object from among the group of pieces of sub-content.

24. A system, comprising:
a head mounted display (HMD);
a processor; and
a memory configured to store instructions thereon, wherein the processor is configured to execute the stored instructions for:
receiving a signal requesting content, wherein the content defines a virtual space displayable on the HMD;
determining sub-content to be displayed in the virtual space;
determining a display condition, wherein the display condition defines a timing for displaying the sub-content in the virtual space; and
instructing the HMD to display the content and the sub-content based on the determined display condition.

25. The system according to claim 24, wherein the processor is further configured to execute the stored instructions for:
determining a location of a virtual camera in the virtual space, wherein a visual-field image displayed by the HMD is based on the location of the virtual camera;
moving the virtual camera in the virtual spaced in response to a detected movement of the HMD.

26. The system according to claim 25, wherein the processor is configured to determine the display condition by determining the display condition based on a first condition defining a relative positional relationship between a visual axis of the virtual camera and a display region of the sub-content.

27. The method according to claim 26, wherein the processor is configured to determine the display condition by determining the display condition based on a second condition defining a time period during which the relative positional relationship is continuously satisfied.

28. The system according to claim 24, wherein the processor is further configured to execute the stored instructions for:
identifying an attribute of a user associated with the user terminal, and
determine the display condition by determining the display condition based on the attribute of the user.

29. The system according to claim 28, wherein the processor is further configured to execute the stored instructions for:
storing history data identifying one of a plurality of pieces of the content displayed on the HMD;
determining an interest level of the user based on the history data, and
identify the attribute of the user by identifying the attribute of the user based on the determined interest level.

30. The system according to claim 24, wherein the processor is configured to determine the display condition based on:
an angle between a visual axis of the virtual camera and a line segment connecting a center position of a display region of the sub-content and a position of the virtual camera, or.
a distance between a position of the display region of the sub-content and an intersection between the visual axis of the virtual camera and a virtual plane including the position of the display region.
